(19) United States
(12) Patent Application Publication
(10) Pub. No.: US 2011/0159961 A1
(43) Pub. Date: Jun. 30, 2011

(54) NETWORKED GAME TERMINAL

(76) Inventor: Boris Itskov, Concord (CA)

(21) Appl. No.: 12/998,016

(22) PCT Filed: Sep. 9, 2009
(86) PCT No.: PCT/CA2009/001227

§ 371 Date: Mar. 9, 2011

(30) Foreign Application Priority Data
Sep. 9, 2008 (CA) 2,639,491

(51) Int. Cl. A63F 13/06

(52) U.S. Cl. 463/37

(57) ABSTRACT

An improved touch screen entertainment terminal for playing of games includes an attract mode having a simulation intended to attract possible patrons to use the terminal for playing of games and a game mode where a game is being played by a user interacting with a touch screen of the terminal. The attract mode provides the simulation on the touch screen in combination with at least one advertising banner positioned to one side of or above or below the simulation. Preferably, the advertising banner is provided on one side of the simulation and the game mode utilizes the touch screen without banner advertisement. The advertising banner can be changed and typically is not associated with the game provider.

### FIELD OF THE INVENTION

The present invention relates to touch screen amusement machines and in particular, such machines adapted to deliver a variety of advertisements to a targeted audience.

### BACKGROUND OF THE INVENTION

Touch screen amusement machines that are typically provided as game terminals and/or game and music terminals in bar and restaurant environments are well known and have provided a series of different entertainment products available to a patron for a pay to play-type application. These terminals have also been known to provide advertisements either associated with the terminal in general or advertising screens that are displayed when the terminal is not active. Such terminals typically have an attract mode and simulated game-type presentations are provided on the screen to demonstrate how a patron can play different games.

With the continued development of computer processors, the types of games played on such terminals have increased in sophistication, and also the size of the touch screen displays have increased. During the play of any of the host of games provided on such a device, the entire display screen is typically used to improve the entertainment value to the patron.

With JVL's most recent game terminal, a large touch screen input is provided (in excess of a 20 inch screen) and the actual play of the game is significantly improved. These game terminals include both older games that were designed for a smaller size terminal display, as well as more recent games that have been developed to take advantage of the larger screen size.

The present invention takes advantage of the capabilities of these new generation terminals, which are typically networked and provide feedback to a centralized collection point, and the adaptation of these terminals to provide an improved advertising vehicle.

### SUMMARY OF THE INVENTION

A touch screen entertainment terminal for playing of games according to the present invention includes an attract mode having a simulation intended to attract possible patrons to use the terminal for playing of games and a game mode where a game is being played by a user interacting with a touch screen of the terminal. The attract mode provides the simulation on the touch screen in combination with at least one advertising banner positioned to one side of or above or below the simulation.

In an aspect of the invention, the advertising banner is provided on one side of the simulation and the game mode utilizes the touch screen without banner advertisement.

### BRIEF DESCRIPTION OF THE DRAWINGS

Preferred embodiments of the invention are shown in the drawings, wherein:

FIG. 1 is a schematic overview of the system, and in particular showing the Terminal Management Server;

FIG. 2 illustrates a new generation game terminal having a large touch screen input;

FIG. 3 is a screen shot of the game terminal promoting a particular game “Treasure Hunt” and providing banner advertising;

FIG. 4 is a schematic view of typical placements of a touch screen in a bar environment;

FIG. 5 is a screen shot showing embedded advertising in a music selection screen;

FIG. 6 is a screen shot of embedded advertising in a screen associated with entry of a high score;

FIG. 7 is a screen shot of advertising provided on a game screen associated with a particular game selection process;

FIG. 8 is a screen shot showing advertising embedded in a game;

FIG. 9 is a screen shot showing additional advertising embedded in a game; and

FIG. 10 illustrates screen shots of an old generation game relative to a new generation game.

### DETAILED DESCRIPTION OF THE PREFERRED EMBODIMENTS

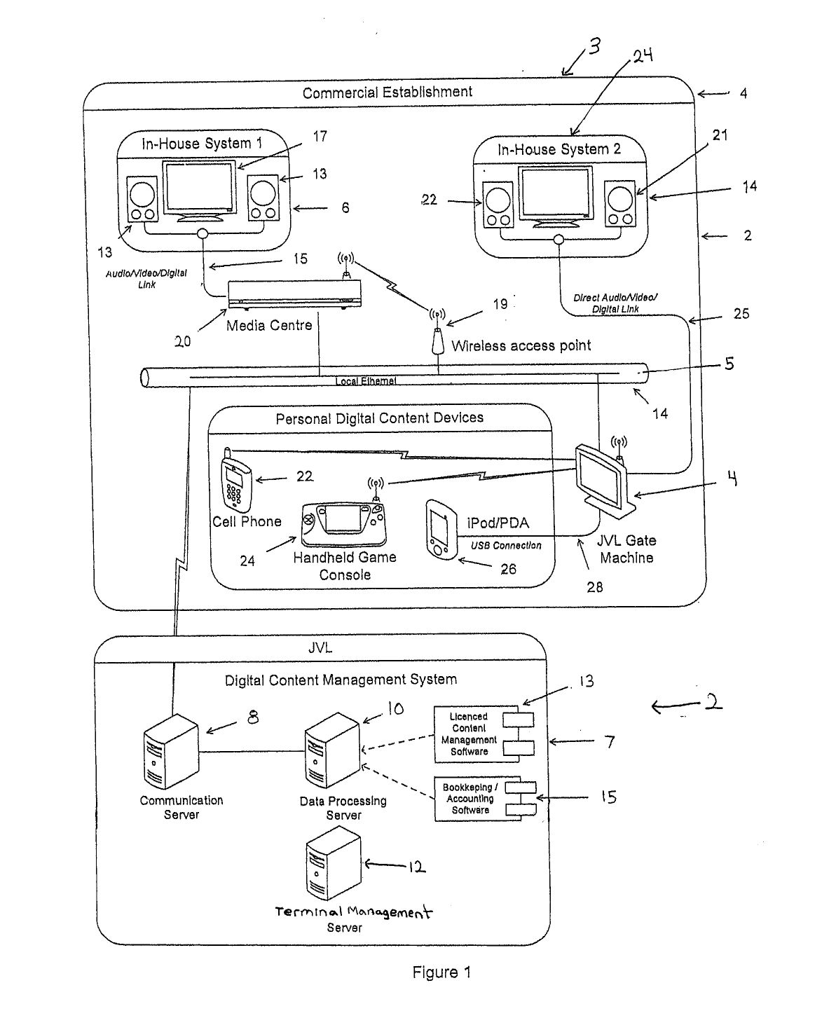

FIG. 1 shows part of a networked game and music system 2 where a game terminal 4 is connected to a local Ethernet network 5 and is in communication with the digital content management system 7 having a communication server 8, a data processing server 10 and a terminal management server 12. The digital content management system 7 is typically at a remote location, and is in communication with a series of commercial establishments having various game terminals 4.

The particular system shown in FIG. 1 also includes a music entertainment function where musical records are provided to the media centre 20 which is also connected to the local Ethernet network 5, and music can be played on the in-house system 22. A further capability to play music in the commercial establishment is associated with the game terminal 4 which is in communication with the in-house system 24. Typically, payments may be made at the game terminal 4 and music played in the commercial establishment indicated as 3. The appropriate licensing for the payment of the musical records is tracked by the data processing server 10 which includes licensed content management software 13 and bookkeeping/accounting software 15. This type of system is known and in particular is known for use in association with networked game terminals. Such networked systems typically have not included a terminal management server 12, which will be described with respect to certain advertisement and tournament arrangements that are associated with the present invention.

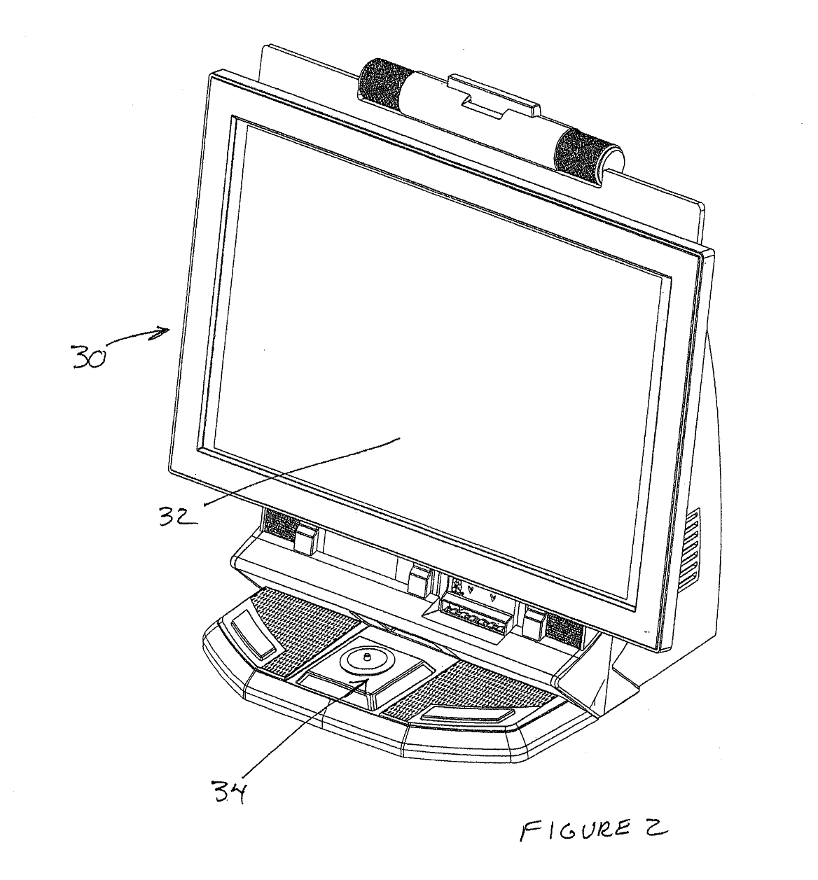

FIG. 2 shows a new generation touch screen terminal 30 including a large touch screen display 32 with the terminal also including a joystick-type controller 34 provided at the base of the terminal. The touch screen terminal 32 is of a large size (in excess of 20 inches) and is preferably at least 22 inches. The large size of the touch screen terminal renders the terminal more appropriate for use in association with banner-type advertising as will be subsequently described.

The game terminal 30 includes a host of games that can be selected according to different categories such as “Cards”, “Puzzle”, “Strategy”, “Action”, “Quiz”, “Erotic”, etc. and the individual terminals at the particular locations also include a geographic coding. The terminals typically will include a location address which can also be used in association with the advertising strategy to be subsequently described.

The game terminals 4, and in particular, the terminal management server 12, maintain statistics with respect to individual terminals, the games played, the time that the game is played and frequency, as well as the geographic location, and other information. For example, in certain aspects of the terminal, like tournament functions, the player is required to register and additional information is tracked, such as the player's age. A database of game statistics is derived, which can be subdivided according to any of the above strategies. For example, the time of day play statistics associated with various terminals is helpful in assessing the type of player that is using the terminal. It is generally known that females are more active in playing of the terminals during daytime hours, whereas males tend to dominate the activity within the evening periods. Furthermore, certain games may have a known gender bias.

The host of games that are available for play on the game terminal is typically in excess of 100 games, and preferably these games are scalable for display at different sizes on the touch input screen 32. With the games being scalable, various banner areas may be provided on the terminal during the actual game play or during an attract mode that the game provides when the terminal is not in active use by a patron.

It has typically been found that the game terminals, although provided in a prime location within a bar or restaurant establishment, are only actively used for a small portion of the available time. For example, if the bar is open for a 12 hour period per day, the terminal will only be in active game mode for a small portion of this period. The terminal will be in an attract mode for a majority of this period, and the attract mode has previously included a series of demonstration-type games where simulated games are shown to promote possible play of the game.

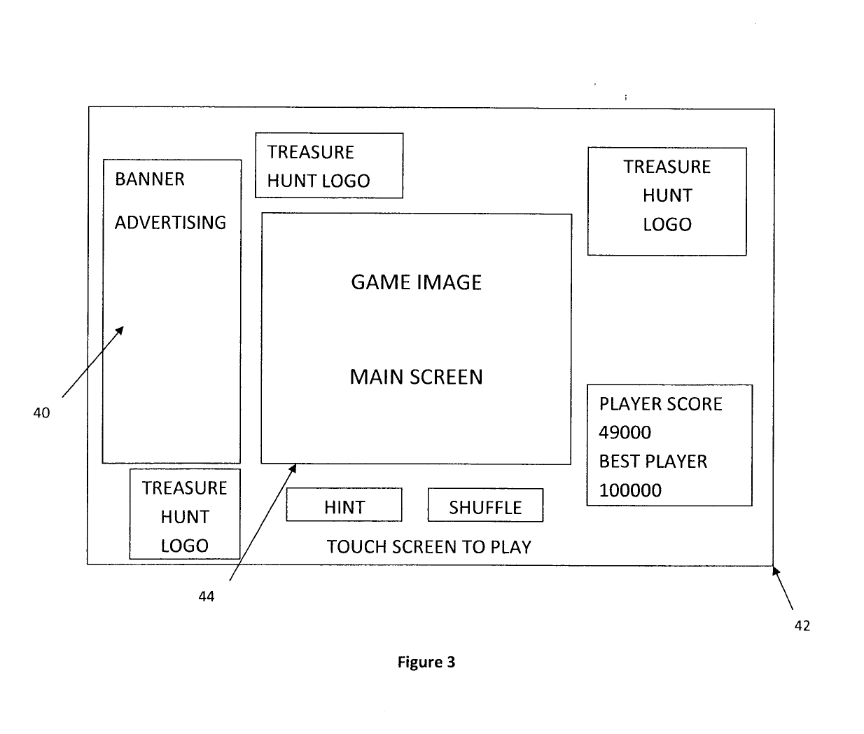

A large touch screen 32 and the ability to use a scaleable output has allowed these typical attract modes to be shown at a reduced scale on the touch screen 32 and provide a banner-type advertisement 40 shown in the display screen 42 of FIG. 3. In this case, the normal attract mode is provided for the game “Treasure Hunt” and this attract mode is generally shown as 44. A banner-type advertisement 40 is provided at the left hand side of the screen. With this arrangement, patrons within the bar who may never play the actual game terminal are exposed to the banner advertisement.

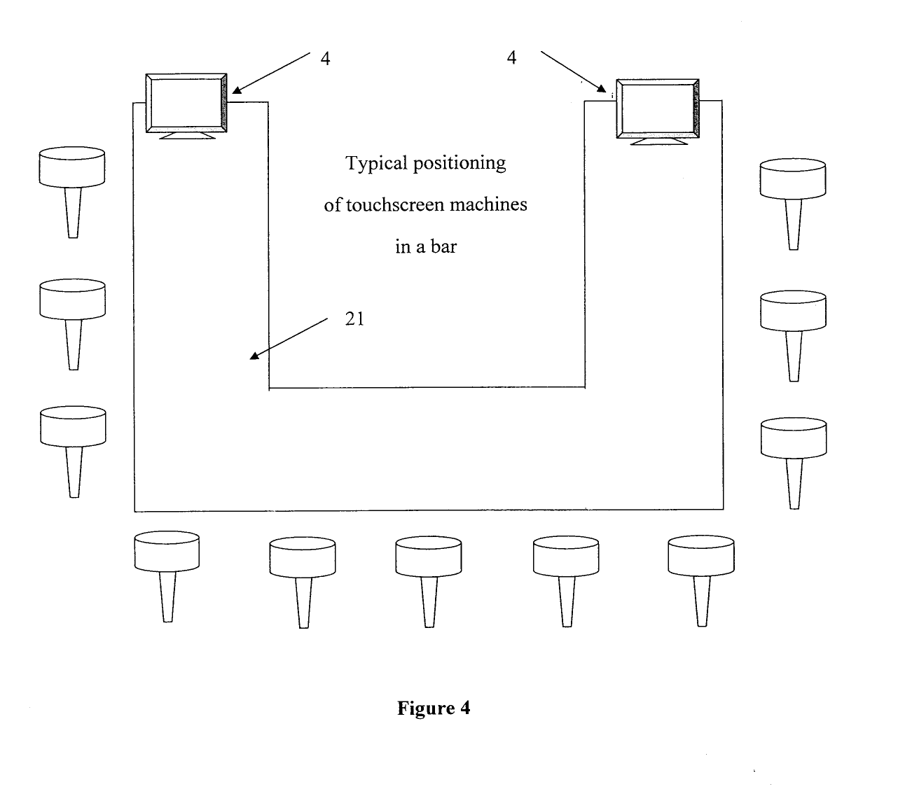

A typical placement of the game terminal 4 is shown in FIG. 4. These are provided at an appropriate location on a bar indicated as 21, and each of the game terminals 4 will be easily observed by two or three patrons if they are located close to such a terminal.

A typical game terminal 4 may deliver in the order of 50 games and 50 songs per day, resulting in a total intermission time (i.e. time in which advertising and the attract mode are conducted) of about 9 hours. During a nine hour period the number of demo or attract mode cycles that can be provided is in the order of approximately 1,000. It can also be appreciated that these demo cycles can also be tracked according to the time of day, and the advertising associated with the demo cycles can be based on the time of day. For example, advertising during the afternoon hours may be at a certain price, whereas banner advertising provided in the evening may be at a different price. Furthermore, the banner advertising can be limited by geographic locations to target game terminals in the northeast, for example, or game terminals in a particular city. It is also possible to provide banner advertising that is more appropriate for display after particular games have been played. The type of games being played can provide an indication of the type of patron that is actually playing the game and appropriate advertising for that patron can be provided. All of this data can be tracked initially by the terminal and subsequently provided to the terminal management server 12.

As the games are scaleable, variations are also possible with respect to the actual size of the banner advertising.

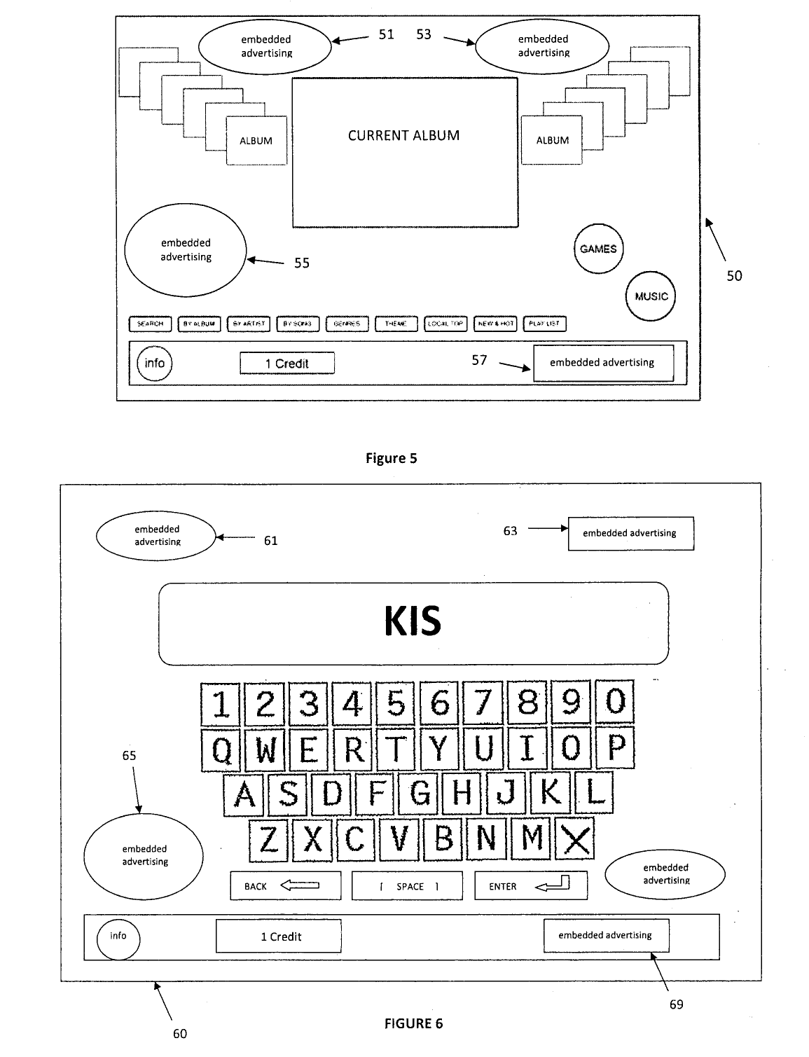

In addition to providing scaleable games that allow effective use of banner advertising in both the game play mode or the attract mode, embedded advertisements in the initial screens associated with a player selecting a particular music product or game product for play can include advertising. Examples of these are shown in FIGS. 5 and 6, where in FIG. 5 embedded advertising is shown as images 51, 53, 55 and 57. In FIG. 6, embedded advertisements are shown as 61, 63, 65, 67 and 69. The screen shot 50 of FIG. 5 is for use in selecting a particular musical song to be played and the screen shot 60 of FIG. 6 is associated with a player entering a particular nick name associated with a high score that has been achieved.

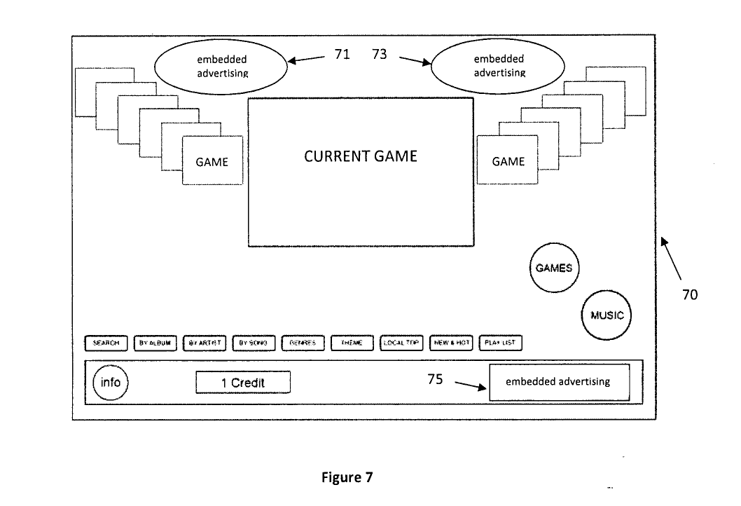

In the screen shot 70 of FIG. 7 embedded advertisements 71, 73 and 75 are shown. This particular screen shot is associated with a game selection screen used to allow the player to select a particular game for play.

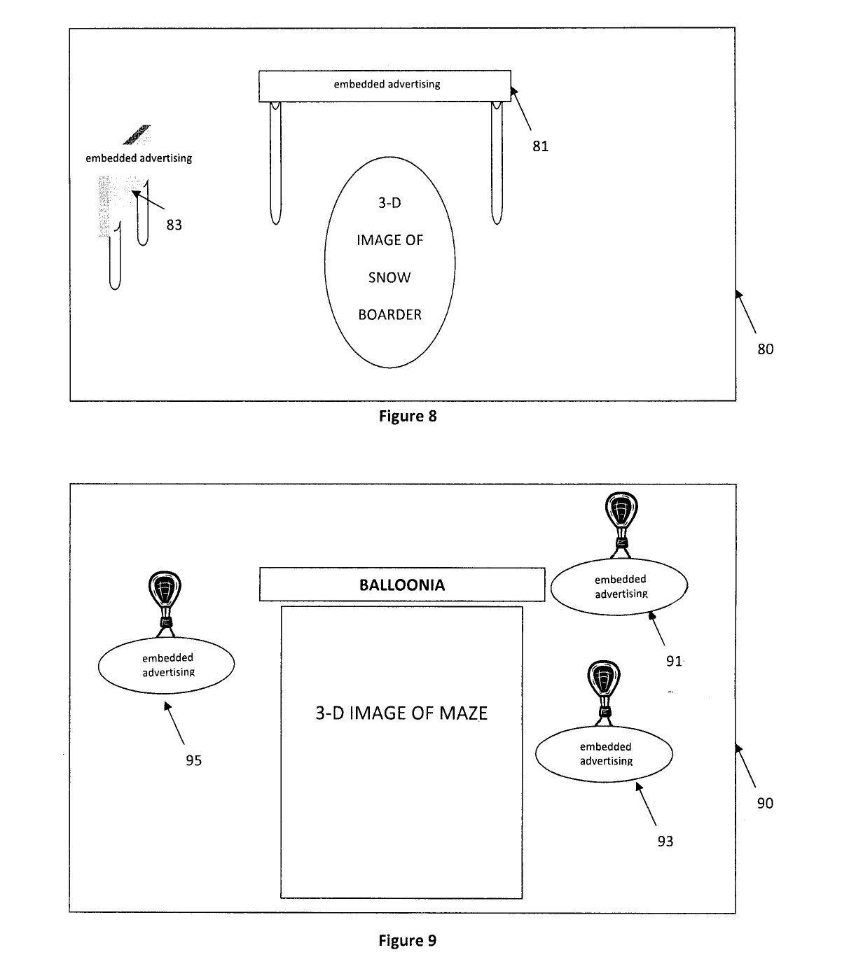

The screen shots of FIGS. 8 and 9 show further examples of advertising, in this case, including advertisements embedded in the game itself. For example see the screen shot 80 which is a screen from a particular game as it is being played that includes embedded advertisements 81 and 83. These are areas within the game program that can easily be altered to allow for different advertisers. The screen shot 90 of FIG. 9 includes embedded advertisements 91, 93 and 95. As can be appreciated, the actual time that the advertisements are displayed can be tracked, and the cost for this type of advertising can vary.

A further example of advertising that can be associated with the game terminal can also include particular promotions by an advertiser. For example, the game terminals 4 include the ability to provide for tournaments and/or game challenges. The tournaments can be restricted by the geographic address of the individual game terminals whereby a local advertiser can include particular advertising and tournament capabilities for regionally located terminals. The actual games for such a tournament, for example, a local weekly league or a particular tournament conducted at a particular time during the week, can have one of the games in a scalable format with appropriate banner advertising associated with this tournament. In this way, the advertiser can customize the advertising for display on the game terminal, and need not attend a particular location to ensure that a particular presentation has associated support material.

A further type of advertising can include a challenge arrangement where the individual tracking of the games could include an option for the player to play a free challenge match versus a different terminal. For example, an advertiser may wish to offer a particular patron who is playing a particular game in a geographic location to have the option to play at their expense or at a reduced rate, a challenge with a further patron in a different commercial establishment. Such challenges or tournaments that are basically conducted based on a particular time or actual use by the terminals, provides a further vehicle for the advertiser to reach his target market. For example, such challenges might be associated with a New York versus Los Angeles tournament, and is based on the accumulated results of challenges over a period of time. This could also be associated with tournaments where results are divided in a geographic manner and include the results based on a different arrangement, for example, the North East versus the South West, or North versus South, etc. It could also be associated with one commercial establishment versus another. These game terminals could be located in a particular chain, and the chain may wish to provide a cross promotion between different locations. This allows for custom advertising, and as the actual challenge can use a scaleable game and appropriate advertising can be associated with it. Also, this type of arrangement can have a special pricing which could be either more expensive or less expensive or fully subsidized.

In a simple promotion, an advertiser may merely wish to offer particular game terminals and players thereof the ability to play a free game at their expense. This could be based on a particular geographic location, a frequency of a game that has been played, or a random-type event. This system can be designed to provide appropriate statistics to the advertiser and can be based on normal advertising frequency rates.

Cross promotion can also be used where particular purchases provide a credit for game play or music play. In this way, use of the game and/or music terminal is encouraged.

In the process of ordering a song or playing a game the players encounter the following common interfaces: “GAME MENU”, “GAME RESULT”, “HALL OF FAME” (when players get into top 10 results for location), “REGISTRATION/LOGIN”, “MUSIC MENU”, “MUSIC SEARCH”, and “MUSIC PLAYLIST BROWSING”.

Those interfaces are the same for all the games (other than game specific imagery). The users of the machine have to touch the screen right next to where the advertisements are shown, which guarantees that all of those advertisements are seen at a very close range.

The examples of advertising placement on those screens are given below. In addition to IAB compliant banners there are ways to embed advertisers' logos in the elements of the game interface.

The present system allows a customized solution for a motivated customer, where an advertising message becomes not an annoyance but part of the game. This solution can include games themed or designed around the message using:

animated 3D objects representing a brand or a product;

customized interface look and feel with advertisers style, colors and logos; and

specially designed games.

Such placements involves substantial setup fees and could be considered on a case by case basis.

Advertisements placed on various screens can be used to deliver e-coupons. Such ads should have clear visual CTA (such as “touch here for a free burger”). Once the ad is touched, a pop up window is shown with conditions of the offer where players can enter their email (or use their registered one) and have the coupon delivered to their inbox.

E-coupons are priced per delivery. Assuming 1% clickthrough rate a charge of about 100 times more per coupon ($2-$5) then per regular impression is believed to be appropriate.

The system supports JPG, PNG and GIF formats. There is a possibility to implement animated GIF as well, if considered appropriate.

A number of games were developed for use on a terminal having a 4×3 ration touch screen display as opposed to the more recent 16×9 ratio touch screen display (wide screen). In order to play games intended for a 4×3 on the newer 16×9 displays, a scaling function is required. Without appropriate adjustment significant distortion occurs and this has not proven satisfactory.

In order to allow play of these older-generation games on the new wide screen terminals, the games provide output using a virtual frame buffer. The latter is displayed at a regular frame rate to a portion of the HD screen, offering seamless game play interactions to the user. This virtualization is achieved as generally described below.

Each old game is hosted in a wrapper HD game (wide screen), making it appear as a valid HD game to the rest of system. On the output end of the process, the HD wrapper provides the hosted game with a virtual frame buffer, and any output from that game is directed entirely to the virtual frame buffer, employing the original draw optimizations in the process. Once a frame is complete, the virtual frame buffer, being a valid HD texture object in itself, of resolution sufficient to hold the old game's original output resolution, is supplied to the actual HD display pipeline as a part of a standard HD drawable, together with its mesh and material, by its host HD game.

On its turn, the drawable employs a special material, designed to provide high-performance, high-quality scaling of the virtual frame buffer texture to whatever the actual HD output resolution is. For the purpose, a custom GPU shader setup is used which does a minimal amount of vertex work directly in screen space, but spends its computational resources in the pixel-shading part doing a spline-based quasi-16-tap image-reconstructive filtering. Spline-based filtering generally provides more visually-pleasing results compared to the standard bilinear filtering, commonly employed for up-scaling purposes in the video industry.

The factors of our spline-based filtering are obtained according to the following function:

sample-factor=((x−9.0/5.0)*x−1.0/5.0)*x+1.0, for x<1.0

sample-factor=((−1.0/3.0*(x−1)+4.0/5.0)*(x−1)−7.0/15.0)*(x−1), for x>=1.0

where x is the distance between the sampling coordinates and the coordinates of the actual texel taken.

This approach can be described as ‘quasi-16-tap’, as the spline-based filtering is applied to 4 pre-filtered elements, each one of which is obtained through hardware-standard (4-tap) bilinear filtering. The filtering is done for performance optimization reasons—as the underlying texture-sampling hardware is deeply optimized for 4-tap bilinear filtering. Asking the software to perform 16 ‘plain’ taps would present a considerable performance waste. Instead, 4 ‘4-tap-prefiltered’ samples are used, and the spline-based filtering is applied to those.

The nature of the filtering is such that the number of taps can be increased, but the coefficient function need not change. Therefore, a future, more-powerful GPU may allow further improvements in up-scaling quality at a minimal development cost.

Another unique property of conversion of older games by up-scaling is the capability for dynamic adjustment of the logical distance between texels in the SD-resolution source material. In terms of the formula above, the thresholds in the ‘x<1.0’ and ‘x>=1.0’ conditions are not fixed at a unit, but are actually programmable, effectively taking the form ‘x<f’ and ‘x>=f’, where f is application-supplied. This allows exploitation of some side-effects of the filtering algorithm, like ‘focusing/de-focusing’ of the up-scaled image in real-time.

This technique provides a preferred approach for allowing play of older generation games on the new generation terminals. Also, the scaling function is used in conjunction with banner advertising if desired.

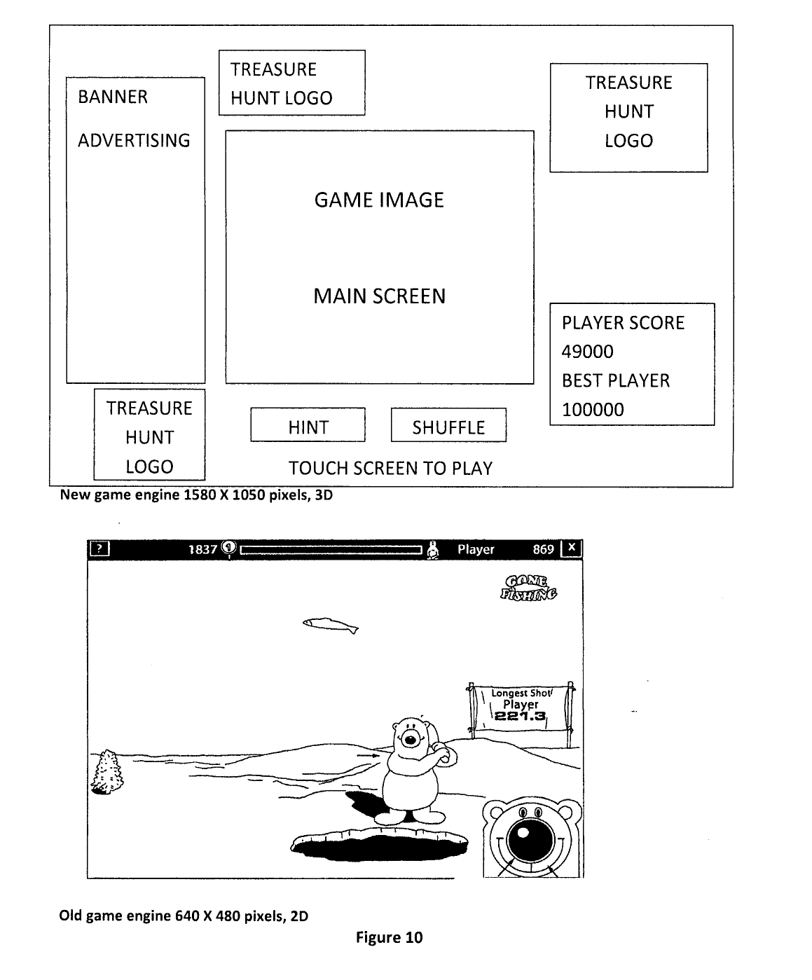

An example of a screen shot of an older generation game relative to a new generation game is shown in FIG. 10.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A touch screen entertainment terminal for playing of games including an attract mode having a simulation intended to attract possible patrons to use the terminal for playing of games and a game mode where a game is being played by a user interacting with a touch screen of the terminal; and
wherein said attract mode provides said simulation on said touch screen in combination with at least one advertising banner positioned to one side of or above or below said simulation.

2. A touch screen terminal as claimed in claim 1 wherein said advertising banner is provided on one side of said simulation and said game mode utilizes the touch screen without banner advertisement.
